(19) United States
(12) Patent Application Publication
(10) Pub. No.: US 2009/0050481 A1
(43) Pub. Date: Feb. 26, 2009

(54) GAS SENSOR WITH INCREASED DURABILITY AND RELIABILITY

(75) Inventor: Tsunetoshi GOTO, Handa-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/193,999

(22) Filed: Aug. 19, 2008

(30) Foreign Application Priority Data
Aug. 24, 2007 (JP) 2007-217808
Jun. 10, 2008 (JP) 2008-151712

(51) Int. Cl. G01N 27/26

(52) U.S. Cl. 204/427

(57) ABSTRACT

A gas sensor is disclosed including a gas-concentration detecting element, a casing accommodating the gas-concentration detecting element, a lead wire delivering a detected voltage potential to an outside, an insulator holding the lead wire in electrical relationship with respect to the housing, a columnar elastic sealing member, air holes formed in the casing for admitting atmospheric air to an inside thereof, and a water repellent filter. The water repellent filter, formed in a cylindrical shape, is disposed between the casing and the insulator, and a cylindrical elastic member is disposed in at least one of an area between the water repellent filter and the casing and another area between the water repellent filter and the insulator. With the casing caulked, the water repellent filter and the cylindrical elastic member are fixed in place.

### CROSS REFERENCE TO RELATED APPLICATIONS

This application is related to Japanese Patent Application Nos. 2007-217808 and 2008-151712, filed on Aug. 24, 2007 and Jun. 10, 2008, respectively, the contents of which are hereby incorporated by reference.

### BACKGROUND OF THE INVENTION

1. Technical Field of the Invention

The present invention relates to gas sensors for detecting measuring gases and, more particularly, to a gas sensor for detecting a concentration of a specified gas component in measuring gases of, for instance, automotive engines or the like.

2. Description of the Related Art

In the related art, attempts have heretofore been made to provide a gas sensor that is mounted on an exhaust pipe of an internal combustion engine such as an automotive engine. The gas sensor detects a concentration of, for instance, a specified gas component such as oxygen in combustion exhaust to output a detection signal. The detection signal, representing the concentration of the specified gas component, is applied to an electronic control unit for controlling an air-fuel ratio or controlling temperatures of an exhaust gas processing catalyst.

For such a gas sensor, an oxygen sensor has been widely used in the past. The oxygen sensor generally includes an oxygen-concentration detecting element composed of an oxygen ion conductive solid electrolyte substrate body. The solid electrolyte substrate body has one surface formed with a measuring electrode layer exposed to measuring gases and the other surface formed with a reference electrode layer exposed to reference gas admitted as reference gas. The oxygen-concentration detecting element detects a difference in voltage potential occurring between the measuring electrode layer and the reference electrode layer due to a difference in an oxygen concentration of measuring gas and an oxygen concentration in reference gas. This allows the oxygen-concentration detecting element to measure the oxygen concentration of measuring gases based on the detected difference in voltage potential.

In normal practice, the gas sensor of such a structure has been used under environments at extremely high temperatures. Further, the gas sensor has been installed on an exhaust pipe in an area outside an engine room at a position in close proximity to drive wheels of a vehicle under severe environments. During operation of the gas sensor, water droplets tend to enter inside the gas sensor from an outside with an accompanying possibility of causing damage to or malfunction of the oxygen-concentration detecting element. Thus, it is required for the gas sensor to have an increased waterproofing effect in order to avoid such defects. Meanwhile, the reference electrode layer needs to be exposed to atmospheric air serving as reference gas and, hence, the gas sensor needs to have increased ventilating capability to allow a flow of reference gas. Thus, there is a need for the gas sensor to address the issues in antinomy between a waterproofing capability and a ventilating capability.

Patent literature 1 (Japanese Patent Application Publication No. 9-178694) discloses an oxygen sensor taking a waterproofing structure including a rubber bush, supporting a lead wire on its outer periphery to provide a hermetic sealing effect, and a metallic cylindrical body disposed in an area outside the rubber bush. The rubber bush has a polytetrafluoroethylene layer formed between the rubber bush and the metallic cylindrical body in an area compressed in a radial direction when the metallic cylindrical body is caulked.

Patent literature 2 (Japanese Patent Application Publication No. 11-72464) discloses an oxygen sensor of another type. The oxygen sensor includes an oxygen detecting element, formed in a shaft-like configuration, and a cylindrical casing accommodating therein the oxygen detecting element. A filter supporting section, taking the form of a cylindrical profile, is coaxially provided in the casing at a rearward area thereof. The filter supporting section has an inner area formed in fluid communication with the casing and a wall portion formed with a single or a plurality of gas guide holes. A filter is placed in a position to close the gas guide holes of the filter supporting section and operative to block the entry of liquid while permitting the entry of gas. A gas guiding structure section is operative to admit atmospheric air to an inside of the casing through the filter and the gas guide holes. A cylindrical protective cover is provided in a position to cover the gas guiding structure section at an outside thereof to avoid liquid droplets from being directly injected to the filter or preventing extraneous matters such as oil or contaminants from adhering to the filter.

With such structures of the gas sensors of the related art disclosed in the Patent Publications set forth above, both of the gas sensors employ water repellent filters, respectively. Each of these water repellent filters is comprised of a fibrous porous structural body, formed in a cylindrical structure, which is made of fluorine resin such as polytetrafluoroethylene or the like. The fibrous porous structural body is sandwiched between an outer cylinder and an inner cylinder placed in a concentric relationship. Then, the fibrous porous structural body is fixed by caulking, thereby preventing water droplets from entering through air holes formed in the outer cylinder (see FIG. 4 of Patent literature 1 and FIG. 3 of Patent literature 2).

When using the fibrous porous structural body, made of fluorine resin such as polytetrafluoroethylene, as the water repellent filter, the water repellent filter encounters plastic deformation at a caulked portion in line with a shape of the outer cylinder. This causes the caulked portion of the water repellent filter to result in a condition known as creeping, which causes irreversible deformation when subjected to mechanical or thermal stress for a given period of time. With the gas sensors of the related art, the water repellent filters encounter the creeping with an accompanying formation of a clearance between the outer cylinder or the inner cylinder and the water repellent filter. Especially, when the gas sensors are exposed to environments at high ambient temperatures, such a clearance is progressively expanded, resulting in a possibility of causing water droplets to enter the gas sensors.

### SUMMARY OF THE INVENTION

The present invention has been completed with a view to addressing the above issues and has an object to provide a gas sensor, having a simplified structure with excellent durability, wherein atmospheric air is easily admitted as reference gas and which is less susceptible to water-incursion.

To achieve the above object, a first aspect of the present invention provides a gas sensor comprising: a gas concentration sensing element composed of a solid electrolyte substrate body, having one surface, formed with a reference electrode layer exposed to a reference gas, and the other surface formed with a measuring electrode layer exposed to measuring gases for detecting a concentration of a specified component contained in the measuring gases; a nearly cylindrical casing for accommodating therein the gas concentration sensing element and having a base end portion formed with air holes to admit atmospheric air as the reference gas to an inside of the casing; a lead wire connected to at least one of the reference electrode layer and the measuring electrode layer and having one end extracted to an outside of the gas sensor; an insulator with which the lead wire is supported in an electrically insulating relationship with respect to the casing; a nearly columnar sealing member covering an outer circumferential periphery of the lead wire and fixedly secured to the casing at the base end portion thereof; a water repellent filter, operative to permit the reference gas to permeate while blocking a liquid from permeating, which has a nearly cylindrical shape and is interposed between the casing and the insulator; and an elastic member having a cylindrical shape and interposed in at least one of an area between the water repellent filter and the casing and another area between the water repellent filter and the insulator. When caulking the casing, the water repellent filter and the cylindrical elastic member are fixedly secured in a position between the casing and the insulator.

With the gas sensor of such a structure, if the water repellent filter is caulked, then the water repellent filter is deformed along the casing. The cylindrical elastic member resiliently presses the water repellent filter at all times such that the casing, the water repellent filter, the cylindrical elastic member and the insulator are held in tight contact with each other. Thus, even if creeping deformation occurs on the water repellent filter, there is still no risk of a clearance being created among the casing, the water repellent filter, the cylindrical elastic member or the insulator. Accordingly, the gas sensor allows the water repellent filter to reliably exhibit a waterproofing effect, thereby obtaining increased durability and reliability.

A second aspect of the present invention provides gas sensor comprising: a gas concentration sensing element composed of a solid electrolyte substrate body, having one surface, formed with a reference electrode layer exposed to a reference gas, and the other surface formed with a measuring electrode layer exposed to measuring gases for detecting a concentration of a specified component contained in the measuring gases; a first nearly cylindrical casing for accommodating therein the gas concentration sensing element; a second nearly cylindrical casing coaxially mounted on the first nearly cylindrical casing at an outside thereof; the first and second casings having base end portions formed with air holes, respectively, to admit atmospheric air as the reference gas to an inside of the first nearly cylindrical casing; a lead wire connected to at least one of the reference electrode layer and the measuring electrode layer and having one end portion extracted to an outside of the gas sensor; a nearly columnar sealing member covering an outer circumferential periphery of the lead wire and fixedly secured to the first casing at the base end portion thereof; an insulator holding the lead wire in an electrically insulating relationship with respect to the first casing; a water repellent filter permitting the reference gas to permeate while blocking a liquid from permeating; and an elastic member formed in a cylindrical shape and interposed in at least one of an area between the water repellent filter and the first casing and another area between the water repellent filter and the second casing. The water repellent filter, formed in a cylindrical shape, is interposed between the first and second casings. By caulking the second casing, the water repellent filter and the cylindrical elastic member are fixedly secured in a position between the first and second casings.

With the gas sensor of such a structure, if the water repellent filter is caulked, then the water repellent filter is deformed along the casing. The cylindrical elastic member resiliently presses the water repellent filter at all times such that the first casing, the water repellent filter, the cylindrical elastic member and the second casing are held in tight contact with each other. Thus, even if creeping deformation occurs on the water repellent filter, no risk takes place for a clearance to be created among the first casing, the water repellent filter, the cylindrical elastic member and the second casing. Accordingly, the gas sensor allows the water repellent filter to reliably exhibit a waterproofing effect, thereby obtaining increased durability and reliability.

More particularly, the cylindrical elastic member may preferably have a rubber hardness ranging from 50 to 90 (in Durometer A) obtained under JIS-K6253: 2006 or ISO48: 1994 and ISO7916-1: 2004. With the cylindrical elastic member selected to have the rubber hardness in such a range, the cylindrical elastic member can complement the creeping of the water repellent filter at the most effective rate. Accordingly, the water repellent filter can have a waterproofing effect in a highly reliable manner, resulting in an increase in durability and reliability of the gas sensor.

With the gas sensor of such a structure, the cylindrical elastic member may preferably have a wall thickness of 1 mm or more. With the cylindrical elastic member selected to have the wall thickness in such a range, the cylindrical elastic member is effective to maintain an elastic force for a long period of time. In addition, the cylindrical elastic member can complement the creeping of the water repellent filter at the most effective rate. Accordingly, the water repellent filter can have a waterproofing effect in a highly reliable maimer, resulting in an increase in durability and reliability of the gas sensor.

With the gas sensor of such a structure, the cylindrical elastic member may preferably have upper and lower ends at least one of which has a deformation absorbent region that absorbs a deformation of the cylindrical elastic member resulting from thermal stress or mechanical stress applied to at least one of the upper and lower ends.

With the gas sensor of such a structure, the cylindrical elastic member is caused to have end faces to swell when it is caulked and fixed in place. Furthers the cylindrical elastic member has a greater thermal expansion coefficient than those of the casing and the insulator. If thermal expansion occurs on the cylindrical elastic member, then the end faces of the cylindrical elastic member are caused to swell. Even in such a case, the cylindrical elastic member can stably retain the water repellent filter in a fixed place without affording any stress in excess to the water repellent filter. Furthermore, no compressive forces act on the end faces of the cylindrical elastic member. This enables the cylindrical elastic member to maintain an elastic force without experiencing permanent deformation even used for a prolonged period of time. Accordingly, the water repellent filter can exhibit a waterproofing effect in a further reliable manner, with an accompanying increase in durability and reliability of the gas sensor.

With the gas sensor, more particularly, the deformation absorbent region may preferably be realized by forming a thin wall portion having at least one of a tapered shape, formed on the cylindrical elastic member at a leading end extending in a decreasing diameter toward a leading end of the gas sensor, a round shape and a stepped shape. Accordingly, this realizes the provision of a gas sensor with increased durability and reliability having an increased waterproofing effect and favorable ventilating effect in combination.

With the gas sensor of the present embodiment, the insulator may preferably have a lead wire insertion bore, permitting the lead wire to be inserted, which has at least one part formed with a longitudinally extending recessed portion spaced from an outer diametrical wall of the lead wire by a clearance of 0.1 mm or more.

With the gas sensor of such a structure, the water repellent filter blocks the entry of water droplets with an accompanying capability of introducing atmospheric air, from which the water droplets are rejected, through the longitudinally extending recessed portion to the reference electrode layer. Consequently, a gas sensor can be realized with a structure having increased durability and reliability while having increased waterproofing capability and a favorable ventilating capability.

With the gas sensor of the present embodiment, the lead wire may preferably have a sheath end portion held in fitting engagement with the lead wire insertion bore.

With the gas sensor of such a structure, the lead wire is fixedly retained with the insulator with an accompanying capability of avoiding the occurrence of disconnection of the lead wire resulting from vibrations thereof. Further, the cylindrical elastic member acts as a shock-absorbing member to absorb vibrations applied to the insulator such that the lead wire becomes less liable to suffer the occurrence of disconnection. Thus, a gas sensor can have further increased reliability.

With the gas sensor of the present embodiment, a reference gas guide passage may be preferably defined between a lower end face of the columnar sealing member and an upper end face of the cylindrical elastic member.

With the gas sensor of such a structure, the water repellent filter blocks the entry of water droplets during a flow of atmospheric air and resulting atmospheric air can be admitted through the reference gas guide passage to the reference electrode layer. Accordingly, this realizes the provision of a gas sensor with increased durability and reliability having an increased waterproofing effect and favorable ventilating effect in combination.

More particularly, the columnar sealing member and the cylindrical elastic member may be preferably disposed in the casing to be separate from each other by a given distance to form the reference gas guide passage between the lower end face of the columnar sealing member and the upper end face of the cylindrical elastic member.

With the gas sensor of such a structure, even when the columnar sealing member is caulked in a fixed place or when thermal expansion occurs on the columnar sealing member, no reference gas guide passage is closed even in the presence of the swelling on the lower end face of the columnar sealing member. In addition, atmospheric air, from which the water droplets are rejected, can be reliably admitted through the reference gas guide passage into the reference electrode layer. Accordingly, a gas sensor can be realized with a structure having increased durability and reliability with an increased waterproofing effect and favorable ventilating effect in combination.

With the gas sensor of the present embodiment, the reference gas guide passage may preferably include a recessed portion formed on the sealing member at a lower end thereof so as to be concaved toward a base end of the gas sensor.

With the gas sensor of such a structure, like the gas sensor of the present embodiment mentioned above, even when the columnar sealing member is caulked in a fixed place or when thermal expansion occurs on the columnar sealing member, no reference gas guide passage is closed even in the presence of the swelling on the lower end face of the columnar sealing member. In addition, atmospheric air, from which the water droplets are rejected, can be reliably admitted through the reference gas guide passage into the reference electrode layer. Accordingly, a gas sensor can be realized with a structure having increased durability and reliability with an increased waterproofing effect and favorable ventilating effect in combination.

With the gas sensor of the present embodiment, the reference gas guide passage may preferably include a recessed portion formed on the insulator at an upper end thereof so as to be concaved toward a leading end portion of the gas sensor.

With the gas sensor of such a structure, like the gas sensor of the present embodiment mentioned above, even when the columnar sealing member is caulked in a fixed place or when thermal expansion occurs on the columnar sealing member, no reference gas guide passage is closed even in the presence of the swelling on the lower end face of the columnar sealing member. In addition, atmospheric air, from which the water droplets are rejected, can be reliably admitted through the reference gas guide passage into the reference electrode layer. Accordingly, a gas sensor can be realized with a structure having increased durability and reliability with an increased waterproofing effect and favorable ventilating effect in combination.

With the gas sensor of the present embodiment, the columnar sealing member may preferably have a lower end portion formed with a cylindrical extension integrally formed with the cylindrical elastic member and the reference gas guide passage may preferably include a passage formed in the cylindrical extension in fluid communication with the air holes of the cylindrical casing.

With the gas sensor of such a structure, the resilient member call be formed with an air hole with an inner diameter determine din consideration of the swelling. Like the gas sensor of the present embodiment mentioned above, even when the columnar sealing member is caulked in a fixed place or when the lower end of the columnar sealing member is swelled, no reference gas guide passage is closed. Thus, atmospheric air, from which the water repellent filter rejects the water droplets, can be reliably admitted through the reference gas guide passage into the reference electrode layer. In addition, the relevant component parts can be easily assembled. Accordingly, a gas sensor can be realized with a structure having increased durability and reliability with an increased waterproofing effect and favorable ventilating effect in combination.

With the gas sensor of the present embodiment, the reference gas guide passage may preferably have an opening portion with an opening diameter greater than that of an inside area of the reference gas guide passage.

With the gas sensor of such a structure, the water repellent filter permits gas to permeate. Thus, water vapor can permeate with atmospheric air through the water repellent filter and is condensed into water when cooled. There is an issue in that this condensed water incurs to the concentration detecting element. However, the gas sensor of the present embodiment can be expected to allow resulting condensed water to accumulate in the water-droplet residential region. This prevents the water droplets from entering the inside of the gas-concentration detecting element. Thus, a gas sensor can have further increased reliability.

With the gas sensor of the present embodiment, the water repellent filter may be preferably made of foaming material.

With the gas sensor of such a structure, when the water repellent filter is caulked and fixed in position, a caulked area of the water repellent filter is densified due to compressive forces applied from the cylindrical seating member and the casing. This causes the water repellent filter to loose a permeating capability with increase density. Thus, the water repellent filter can have a non-compressed area, not compressed when the casing is caulked, which ensures a fluid communication with the air holes to permeate gas. Accordingly, a gas sensor can have further increased reliability.

With the gas sensor of the present embodiment, the water repellent filter may preferably include a cylindrical body made of polytetrafluoroethylene.

With the gas sensor of such a structure, the cylindrical elastic member can compliment the creeping of the water repellent filter, making it possible to realize a gas sensor with increased durability while having increased ventilating capability and waterproofing capability in combination.

According to a third aspect of the present invention, there is provided a gas sensor comprising: a gas concentration sensing element composed of a solid electrolyte substrate body, having one surface, formed with a reference electrode layer exposed to a reference gas, and the other surface formed with a measuring electrode layer exposed to measuring gases for detecting a concentration of a specified component contained in the measuring gases; a nearly cylindrical casing having a large diameter portion and a small diameter portion for accommodating therein the gas concentration sensing element and having air holes formed in the small diameter portion to admit atmospheric air as the reference gas to an inside of the casing; a lead wire axially extending through the small diameter portion of the casing and connected to at least one of the reference electrode layer and the measuring electrode layer and having one end extracted to an outside of the gas sensor; an insulator having a large diameter portion, fixedly supported in the large diameter portion of the casing, and a small diameter portion extending through the small diameter portion of the casing, the small diameter portion of the insulator having a lead wire insertion bore, supporting the lead wire in an electrically insulating relationship with respect to the casing, and at least one recessed portion to allow the reference gas to pass to the gas concentration sensing element; a nearly columnar sealing member covering an outer circumferential periphery of the lead wire and fixedly secured to the casing at a base end portion thereof; a nearly cylindrical water repellent filter axially extending in an area between the casing and the insulator for permitting the reference gas to permeate while blocking a liquid, contained in the reference gas, from permeating; and a cylindrical elastic member interposed in at least one of an area between the water repellent filter and the casing and another area between the water repellent filter and the insulator. When caulking the casing, the water repellent filter and the cylindrical elastic member are fixedly secured in a position between the casing and the insulator.

With the gas sensor of such a structure, if the water repellent filter is caulked, then the water repellent filter is deformed along the casing. The cylindrical elastic member resiliently presses the water repellent filter at all times such that the casing, the water repellent filter, the cylindrical elastic member and the insulator are held in tight contact with each other. Thus, even if creeping deformation occurs on the water repellent filter, no risk takes place for a clearance to be created among the casing, the water repellent filter, the cylindrical elastic member and the insulator. Accordingly, the gas sensor allows the water repellent filter to reliably exhibit a waterproofing effect, thereby obtaining increased durability and reliability.

### BRIEF DESCRIPTION OF THE DRAWINGS

FIG. 1 is a longitudinal cross sectional view showing a gas sensor of a first embodiment according to the present invention.

FIG. 2A is a cross-sectional view showing a major part of the gas sensor in an enlarged scale to represent an advantageous effect of the gas sensor of the first embodiment according to the present invention.

FIG. 2B is a cross-sectional view of the gas sensor taken on line 1A-1A in FIG. 2A.

FIG. 3 is a longitudinal cross sectional view showing a gas sensor of a second embodiment according to the present invention.

FIG. 4 is a cross-sectional view showing a major part of the gas sensor in an enlarged scale to represent an advantageous effect of the gas sensor of the second embodiment according to the present invention.

FIGS. 5A to 5D are perspective views showing various exemplary profiles of cylindrical elastic members, partly cut away, for use in gas sensors of various embodiments according to the present invention.

FIGS. 6A to 6C are fragmentary cross-sectional views showing various modified forms of the gas sensor of the second embodiment shown in FIG. 2.

FIG. 7A is a longitudinal cross-sectional view showing an overall structure of a gas sensor of a third embodiment according to the present invention.

FIG. 7B is a cross sectional view of the gas sensor taken on line 7A-7A of FIG. 7A.

FIG. 8 is a longitudinal cross-sectional view showing a major part of a gas sensor of a fourth embodiment according to the present invention.

FIG. 9 is a fragmentary cross-sectional view showing a major part of a gas sensor of a fifth embodiment according to the present invention.

FIG. 10 is a fragmentary cross-sectional view showing a major part of a gas sensor of a sixth embodiment according to the present invention.

FIG. 11 is a longitudinal cross-sectional view showing an overall structure of a gas sensor of a seventh embodiment according to the present invention.

### DETAILED DESCRIPTION OF PREFERRED EMBODIMENTS

Now, gas sensors of various embodiments according to the present invention will be described below in detail with reference to the accompanying drawings. However, the present invention is construed not to be limited to such embodiments described below and technical concepts of the present invention may be implemented in combination with other known technologies or the other technology having functions equivalent to such known technologies.

In the following description, it is construed that a portion of the gas sensor adapted to be inserted to a measuring gas flow passage is referred to as a “leading end portion” and an opposite side of the gas sensor exposed to an atmosphere is referred to as a “base end” or a “base end portion” with LE and BE indicating the leading end portion and the base end portion of each gas sensor, respectively.

Also, it will be appreciated that each gas sensor of the present embodiment according to the present invention may have a wide variety of applications to an oxygen sensor, an A/F sensor, a NOx sensor, etc.

### First Embodiment

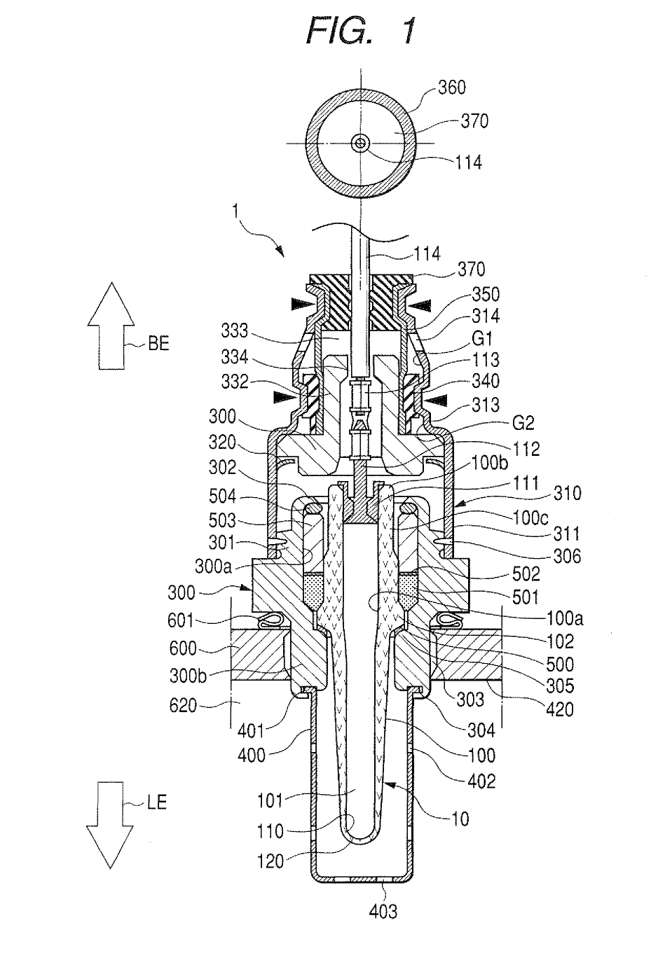

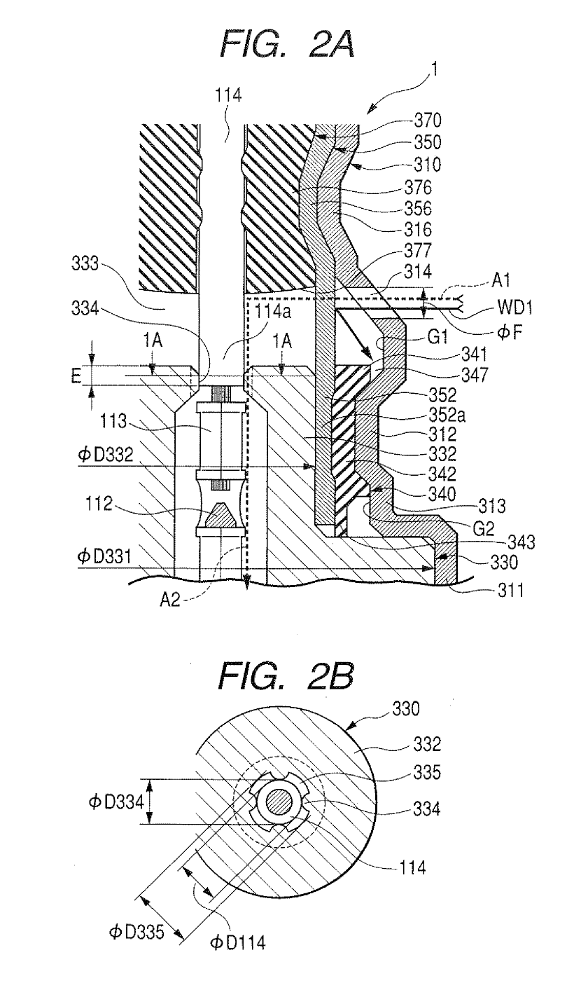

A gas sensor of a first embodiment according to the present invention is described below in detail with reference to FIG. 1 and FIGS. 2A and 2B.

FIG. 1 is a cross section showing an overall structure of the gas sensor 1 of the first embodiment according to the present invention. FIGS. 2A and 2B show an essential part of the gas sensor 1 in enlarged scale for illustrating an advantageous effect thereof.

The gas sensor 1 of the first embodiment is of a heaterless gas sensor mounted on a combustion exhaust passage of an internal combustion engine, such as an automotive engine and an automotive two-wheeled vehicle engine, at a position closer to an exhaust pipe of the internal combustion engine. The gas sensor 1 has a gas-concentration detecting element that is activated upon utilizing combustion exhaust gases with high temperatures.

As shown in FIG. 1, the gas sensor 1 comprises the gas-concentration detecting element 10 including a bottomed solid electrolyte substrate body 100. The solid electrolyte substrate body 100 is made of oxygen-ion conductive solid electrolyte material such as zirconia or the like and has a cylindrical bottomed structure with a leading end being closed. With such a structure, the solid electrolyte substrate body 100 has an inner and outer peripheral surfaces formed with a porous reference electrode layer 110 and a measuring electrode layer 120, respectively. The porous reference electrode layer 110 and the measuring electrode layer 120 are made of platinum or platinum alloy. The solid electrolyte substrate body 100 internally has a reference gas introducing chamber 101. The solid electrolyte substrate body 100 has an intermediate portion formed with a radially and outwardly extending substrate fixing portion 102 with an increased diameter.

The solid electrolyte substrate body 100 has an axially extending hole 10a and a base end portion 100b carrying therein a metal fitting 111. The metal fitting 111 includes a tubular connecting portion, partly cut away, which is slightly larger in diameter than an inner diameter of the hole 100a of the solid electrolyte substrate body 100. The tubular connecting portion of the metal fitting 111 is compressed in diameter to be inserted to the hole 100a in a position closer to the base end portion 100b. This allows the tubular connecting portion of the metal fitting 111 to be resiliently held in tight contact with the reference electrode layer 110 in an electrically conductive state. The tubular connecting portion of the metal fitting 111 has a base end portion formed with a terminal portion 112, which is electrically connected to a lead wire 114 via a compressed metal fitting 113. The lead wire 114 is electrically connected to an electronic control device, which is not shown.

The gas sensor 1 further includes a casing 310 internally carrying therein a stepped cylindrical insulator 330 with which the lead wire 114 is held in an electrically insulating capability. The casing 310 has inwardly and radially extending cramping segments 320 with which the insulator 330 is retained in a fixed place. The insulator 330 has a base end portion formed with a small diameter portion 332, to which a cylindrical elastic member 340 is inserted. A cylindrical water repellent filter 350 is interposed between the cylindrical elastic member 340 and a small diameter portion 313 of the casing 310.

Further, the small diameter portion 313 of the casing 310 has a base end portion hermetically sealed with a nearly columnar elastic sealing member 370. The small diameter portion 313 of the casing 310 has an axially intermediate area formed with a plurality of air holes 314 through which atmospheric air is intruded as reference gas into an inside of the casing 310. During a flow of atmospheric air into the casing 310, the water repellent filter 350 avoids the entrance of liquid with only gas permitted to pass into the inside of the casing 310. In addition, moisture, contained in atmospheric air passed to the inside of the casing 310, can escape through the water repellent filter 350.

The solid electrolyte substrate body 100 is inserted to a nearly cylindrical housing 300 made of heat resistant metal such as stainless steel or the like. The cylindrical housing 300 internally has a tapered engaging shoulder 305, formed in a small diameter area, on which the substrate fixing portion 102 rests via a metallic sealing member 500. The solid electrolyte substrate body 100 has a cylindrical portion 100c, extending between the substrate fixing portion 102 and the base end portion 100b, which is radially spaced from an inner bore 300a internally formed in the housing 300 to define an annular space. Ceramic powder is filled in a lower area of the annular space between the cylindrical portion 100c of the solid electrolyte substrate body 100 and the inner bore 300a of the housing 300. In addition, a tubular ceramic retainer member 503 is also inserted to the annular space between the cylindrical portion 100c of the solid electrolyte substrate body 100 and the inner bore 300a of the housing 300 in an area above ceramic powder. A ring-like metallic sealing member 504 is disposed in the inner bore 300a of the housing 300 at a top of the tubular ceramic retainer member 503. In assembling the solid electrolyte substrate body 100 and the housing 300 to each other, a caulking portion 302, formed on the housing 300 at a base end thereof, is caulked to fixedly retain the ceramic powder 501, the tubular ceramic retainer member 503 and the metallic sealing member 504. This allows the substrate fixing portion 102 of the solid electrolyte substrate body 100 to be fixedly retained with the housing 300 in hermetically sealed condition. Thus, the measuring electrode layer 120 is kept in electrical conduct with the housing 300 by means of the metallic sealing member 500.

The housing 300 has a base end portion formed with a boss portion 301 to which a large diameter portion 310b of the casing 310 is fitted with a leading end of the large diameter portion 310b being fixedly secured to the boss portion 301 of the housing 300 by laser welding 306 or the like.

The housing 300 has a leading end portion 300b having an outer periphery formed with a threaded portion 303 that is screwed into a combustion exhaust passage wall 600 of an internal combustion engine (not shown) via a gasket 601 such that a leading end portion of the gas-concentration detecting element 10 is exposed to combustion exhaust gases passing through a combustion exhaust gas passage 420. Under such a mounted state, the measuring electrode layer 120 is kept under a grounded state with the combustion exhaust passage wall 600, serving as ground, via the housing 300.

Further, the gas sensor 1 has the leading end portion, directed in an arrow LE, which is exposed to measuring gases. The gas-concentration detecting element 10 is covered with a nearly hat-shaped cover body 400 for protection. The cover body 400 has a base end formed with a radially and outwardly extending flange portion 401, which is fixedly retained with the leading end portion 300b of the housing 300 at a distal end thereof by means of a caulked portion 304 of the housing 300.

The cover body 400 has a circumferential sidewall, formed with a plurality of sidewall openings 402, and a bottom wall formed with a plurality of bottom wall openings 403 with a view to admitting measuring gases to an inside of the cover body 400 while discharging the same to the outside of the cover body 400.

Referring to FIGS. 2A and 2B, detailed description will be given of a major structure of the base end portion, directed in a direction indicated by an arrow BE, of the gas sensor 1 constituting an essential part of the present invention.

FIG. 2A is a cross-sectional view showing an essential part of the base end portion of the gas sensor 1 of the present embodiment in enlarged scale and FIG. 2B is a cross section taken on line 1A-1A of FIG. 2A.

The insulator 330 is disposed inside the casing 310 to keep the lead wire 114 and the casing 310 in an electrically insulated relationship. The insulator 330 has a large diameter portion 331 whose outer circumferential periphery is constrained with an inner circumferential periphery of the large diameter portion 310b of the casing 310. The small diameter portion 332 of the insulator 330 is fixedly retained with the cylindrical elastic member 340. The cylindrical elastic member 340 has an axially intermediate portion formed with a first caulked portion 342 that is caulked with a first caulked portion 312 of the casing 310 via a first caulked portion 352a of the water repellent filter 350. Thus, the insulator 330 is rigidly retained between the first caulked portion 312 of the casing 310 and the cramping segments 320 thereof in a clamping relationship as shown in FIG. 1.

The small diameter portion 332 of the insulator 330 has a base end formed with a lead wire insertion bore 334. A leading end 114a of the lead wire 114 is held in fitting engagement with the lead wire insertion bore 334 of the insulator 330 such that the lead wire 114 and the terminal portion 113 are kept in an electrically insulated relationship. The leading end 114a of the lead wire 114 is inserted to the lead wire insertion bore 334 only by a depth E (of 0 mm or more). The lead wire insertion bore 334 is formed with longitudinally extending recessed portions 335 with a diameter greater than a sheath outer diameter φD114 of the lead wire 114. The recessed portion 335 has an inner diameter φD335 determined so as to form a clearance of 0.1 mm or more between the recessed portion 335 and the lead wire 114. This makes it possible to easily pass atmospheric air to the inside of the insulator 330.

The nearly cylindrical water repellent filter 350 has a leading end portion 352, forming an essential part of the present invention, that is held in fitting engagement with the small diameter portion 332 of the insulator 330. In addition, the nearly cylindrical elastic member 340 is interposed between the small diameter portion 313 of the casing 310 and the leading end portion 352 of the nearly cylindrical water repellent filter 350. The small diameter portion 313 of the casing 310 is caulked at a first caulked portion 312 from the outside thereof such that a part of the small diameter portion 313 is convexed radially inward, thereby fixedly retaining the leading end portion 352 of the nearly cylindrical water repellent filter 350 and the nearly cylindrical elastic member 340.

The water repellent filter 350 takes the form of a tubular structure comprised of a compact body, made of fluorine resin such as polytetrafluoroethylene or the like, which is extended in directions of more than one axis at heating temperatures below a melting point of the compact body to form a fibrous porous structural body. The fibrous porous structural body can permit gas to permeate while blocking liquid from permeating.

A pressing force, arising when forming the first caulked portion 312 of the casing 310 at the small diameter portion 313 thereof is resiliently transferred to a first caulked portion 352a of the water repellent filter 350. This allows the first caulked portion 352a of the water repellent filter 350 to be fixedly supported on the small diameter portion 332 of the insulator 330 without causing any clearance to be present due to the creeping of the water repellent filter 350.

Meanwhile, the first caulked portion 352a of the water repellent filter 350 encounters the creeping when used for a long period of time with an accompanying risk of the formation of a clearance between the first caulked portion 352a of the water repellent filter 350 and the first caulked portion 312 of the casing 310. However, the nearly cylindrical elastic member 340 provides an elastic force to compensate so as to prevent the formation of such a clearance, ensuring the gas sensor 1 has airtightness and water-tightness at all times thereby clocking the entry of water droplets.

The small diameter portion 313 of the casing 310 has circumferentially spaced air holes 314 through which atmospheric air is admitted as reference gas into the casing 310. The cylindrical elastic member 340 has an upper end 341 placed apart from the air holes 314 to be closer to a leading end LE of the gas sensor 1. The small diameter portion 313 of the casing 310 has a base end portion that decreases in diameter in an area from a point in close proximity to the air holes 314 to a base end of the small diameter portion 313, thereby defining a tapered annular gap G1 between the cylindrical water repellent filter 350 and the casing 310.

Thus, even if the cylindrical elastic member 340 and the cylindrical water repellent filter 350 are compressed with the first caulked portion 352a of the casing 310, no compressing force acts on the upper end 341 of the cylindrical elastic member 340. Thus, no permanent deformation occurs on the cylindrical elastic member 340 even when used for a long period of time, making it possible to prevent any deterioration in elastic force.

Further, the cylindrical elastic member 340 has a lower end 343 that has an outer circumferential periphery cut out in a reduced diameter, thereby forming an annular gap G2 between the small diameter portion 313 of the casing 310 and the lower end 343 of the cylindrical elastic member 340.

The annular gaps G1 and G2, formed in upper and lower areas adjacent to the upper and lower ends 341 and 343 of the cylindrical elastic member 340, have functions to serve as deformation absorbent regions. The cylindrical elastic member 340 has a greater thermal expansion coefficient than those of the casing 310 and the insulator 330. Thus, if the cylindrical elastic member 340 is thermally expanded, the upper and lower ends 341 and 343 of the cylindrical elastic member 340 are caused to swell. Thus, the cylindrical water repellent filter 350 can be stably positioned in a fixed place.

Furthermore, even if atmospheric air passes through the air holes 314 followed by a flow of water droplets as indicated by arrows A1 and WD1 in FIG. 1, the cylindrical water repellent filter 350 blocks the entry of water droplets. In this moment, the water droplets, rejected with the cylindrical water repellent filter 350, drop as indicated by an arrow WD2 in FIG. 2A. Then, the water droplets fall down and are accumulated in a water-droplet accumulating region 347 defined in a large gap between the upper end 341 of the cylindrical elastic member 340 and the small diameter portion 313 of the casing 310. Thus, atmospheric air is permitted to pass through the insulator 330 in a direction as indicated by an arrow A2 in FIG. 2A with no risk taking place for the water droplets to penetrate to an area near the gas-concentration detecting element 10.

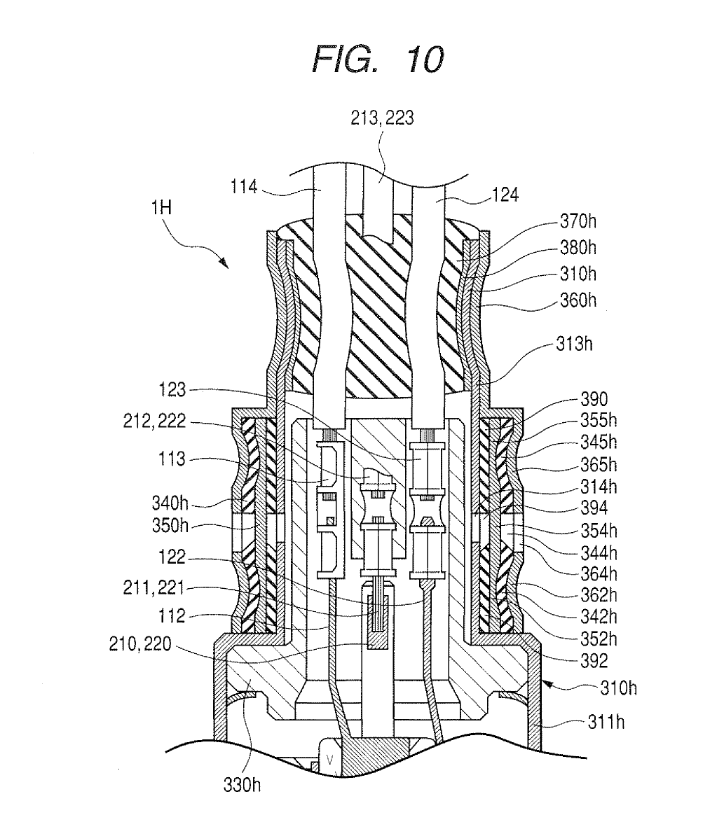

With the gas sensor 1 of the present embodiment shown in FIG. 10, the small diameter portion 313 of the casing 310 accommodates therein a columnar elastic sealing member 370. The columnar elastic sealing member 370 has an outer circumferential wall that is caulked with a second caulked portion 316j of the casing 310 such that the second caulked portion 316 has an inner circumferential wall convexed radially inward. Thus, the second caulked portion 316 allows both the columnar elastic sealing member 370 and the cylindrical water repellent filter 350 to be rigidly fixed in position.

The cylindrical water repellent filter 350 has a second caulked portion 376 that is deformed in conformity to a shape of the second caulked portion 316 of the casing 310. In this moment, the second caulked portion 356 of the cylindrical water repellent filter 350 is compressed and densified in structure with the second caulked portion 316 of the casing 310 and the second caulked portion 376 of the columnar elastic sealing member 370, resulting in an increase in airtightness.

Moreover, the cylindrical elastic member 340 and the columnar elastic sealing member 370 may be preferably comprised of elastic members made of rubbers or the like with rubber hardness ranging from 50 to 90 (based on Durometer A) under JIS-K6253: 2006, ISO48: 1994 or ISO7916-1: 2004.

JIS-K6253: 2006 corresponds to ISO48: 1994 and ISO7916-1: 2004.

It has been discovered that with the cylindrical elastic member 340 having rubber hardness in such a range, the cylindrical elastic member 340 can have the most effective result of preventing the water repellent filter 350 from creeping.

In addition, the cylindrical elastic member 340 may preferably have a wall thickness of 1 mm or more. A further discovery is that with the cylindrical elastic member 340 determined to have such a wall thickness, the cylindrical elastic member 340 can maintain an elastic force for a long period of time with the most effective result of suppressing the occurrence of creeping of the water repellent filter 350.

In regards to the cylindrical elastic member 340 and the columnar elastic sealing member 370, these members may be preferably composed of other elastic members with increased heat resistance such as fluorine rubber and silicone rubber or the like, with accompanying expectations of increased durability.

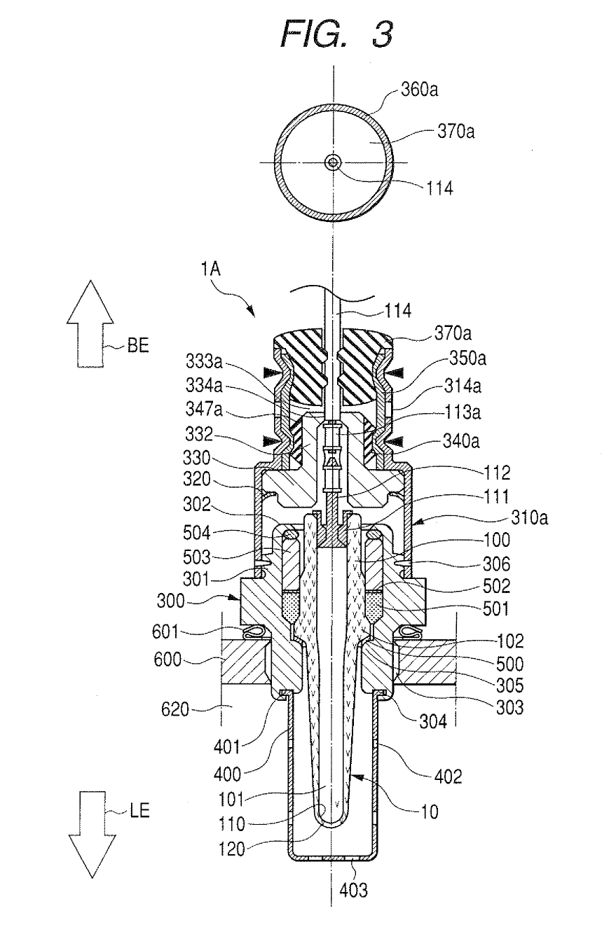

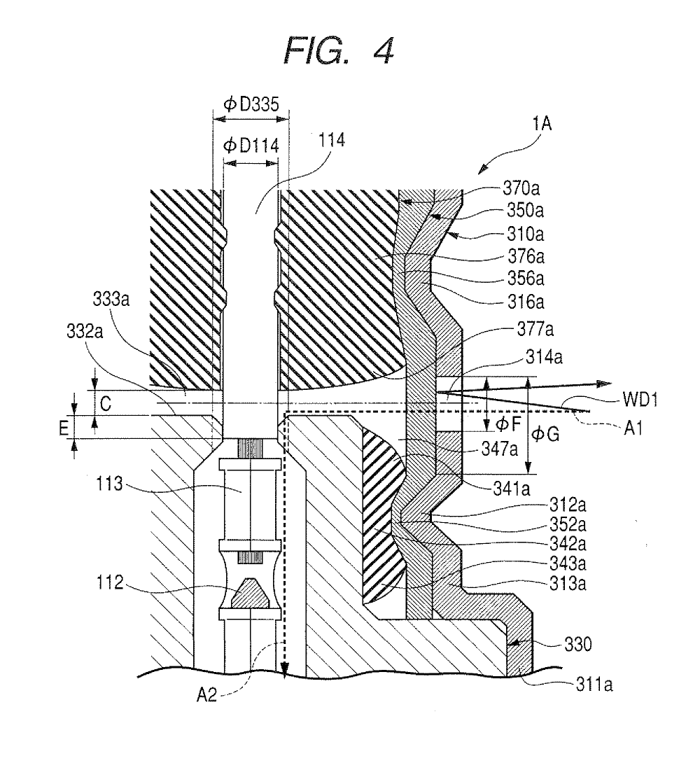

Next, a gas sensor 1A of a second embodiment according to the present invention will be described below with reference to FIGS. 3 and 4.

In the following description, the same component parts as those of the first embodiment bear like or reference numerals and the other component parts with the same functions and modes as those of the first embodiment bear like reference numerals affixed with alphabet symbols to omit redundant description. Gas sensors of other various embodiments will be described with a focus on featuring differences.

The gas sensor 1A of the second embodiment differs from the gas sensor 1 of the first embodiment in that a cylindrical elastic member 340a is fitted to an outer periphery of the small diameter portion 332 of the insulator 330 and a water repellent filter 350a is interposed between the cylindrical elastic member 340a and a casing 310a.

FIG. 3 is a cross-sectional view showing an overall structure of the gas sensor 1A of the second embodiment according to the present invention. FIG. 4 is a cross-sectional view showing an essential part of a base end portion of the gas sensor 1A of the present embodiment.

The nearly cylindrical elastic member 340a is tightly fitted to the small diameter portion 332 of the insulator 330 according to an essential feature of the present invention. In addition, the water repellent filter 350a is interposed between a small diameter portion 310a of the casing 310a and the cylindrical elastic member 340a. The casing 310a is caulked on a first caulked portion 312a at an outside thereof to cause a part of the small diameter portion 310a to be convexed radially inward for fixedly supporting the water repellent filter 350a and the cylindrical elastic member 340a.

The water repellent filter 350a has a first caulked portion 352a, which is deformed in conformity to the first caulked portion 312a of the casing 310a. In this case, the first caulked portion 352a of the water repellent filter 350a is resiliently pressed with a first caulked portion 342a of the cylindrical elastic member 340a, causing the first caulked portion 352a of the water repellent filter 350a to have increased airtightness.

The small diameter portion 313a of the casing 310a has air holes 314a for admitting atmospheric air as reference gas into the casing 310a. The cylindrical elastic member 340a has upper and lower end portions 341a and 343a formed in tapered structures, respectively. Therefore, even if the first caulked portion 312a of the casing 310a compresses the cylindrical elastic member 340a together with the water repellent filter 350a, no compressing force is applied to the upper and lower end portions 341a and 343a of the cylindrical elastic member 340a. Thus, no permanent deformation occurs on the cylindrical elastic member 340a even if it is used for a long period of time, thereby preventing the occurrence of deterioration in an elastic force of the cylindrical elastic member 340a.

In addition, the cylindrical elastic member 340a has a greater thermal expansion coefficient than those of the casing 310a and the insulator 330. Thus, even if the cylindrical elastic member 340a is subjected to thermal expansion with accompanying occurrence of swellings formed on the upper and lower end portions 341a and 343a, the water repellent filter 350a encounters no stress in excess and can be fixedly secured in place in a stable manner.

With the upper end portion 341a formed in a tapered shape, further, the gas sensor 1A has an increased airspace, defined between a lower end face 377a of the columnar elastic sealing member 370a and the upper end portion 341a of the cylindrical elastic member 340a, which can be utilized as a water-droplet accumulating region 347.

An upper end face 332a of the insulator 330 is axially spaced from a lower end face 377a of the columnar elastic sealing member 370a by a distance C of 0.1 mm or more, resulting in the formation of a reference gas guide passage 333a.

The air hole 314a has an inner diameter φF greater than the distance C and the water-droplet accumulating region 347a has an opening diameter φG made greater than the inner diameter φF of the air hole 314a.

Water vapor, contained in atmospheric air admitted through the air holes 314a as indicated by the arrow A1 in FIG. 4, permeates through the water repellent filter 350a to enter the inside of the casing 310a. If such water vapor is cooled with an outside air stream at low temperatures, then dew condensation of water vapor occurs on an inner circumferential surface of the casing 310a or an inner circumferential surface of the water repellent filter 350a to form water-droplets. However, the water-droplet accumulating region 347a has an opening diameter that increases radially outward. Thus, even if the water droplets occur inside the casing 310a, the resulting water droplets can be adequately accumulated in the water-droplet accumulating region 347a. Thus, no water droplet enters an inside of the gas-concentration detecting element 10 to which only atmospheric air is delivered as reference gas as indicated by the arrow A2 in FIG. 4.

The columnar elastic sealing member 370a has a compressed portion 376a compressed with a second caulked portion 316a of the casing 310a and a second caulked portion 356a of the water repellent filter 350a. In this case, the small diameter portion 310a of the casing 310a is caulked radially inward at the second caulked portion 316a. Thus, the columnar elastic sealing member 370a and the water repellent filter 350a are fixedly retained with the small diameter portion 313a of the casing 310a.

The lower end face 377a of the columnar elastic sealing member 370a is formed in a tapered portion to which almost no compressing force is applied. Thus, the columnar elastic sealing member 370a can suppress the occurrence of permanent deformation as experienced with the cylindrical elastic member 340a, making it possible to allow the columnar elastic sealing member 370a to maintain an elastic force for a long period of time. The second caulked portion 356a of the water repellent filter 350a is deformed in conformity to the shape of the second caulked portion 316a of the small diameter portion 313a of the casing 310a. This causes the second caulked portion 316a of the small diameter portion 313a of the casing 310 and the compressed portion 376a of the columnar elastic sealing member 370a to compress and densify the second caulked portion 356a of the water repellent filter 350a, resulting in an increase in airtightness.

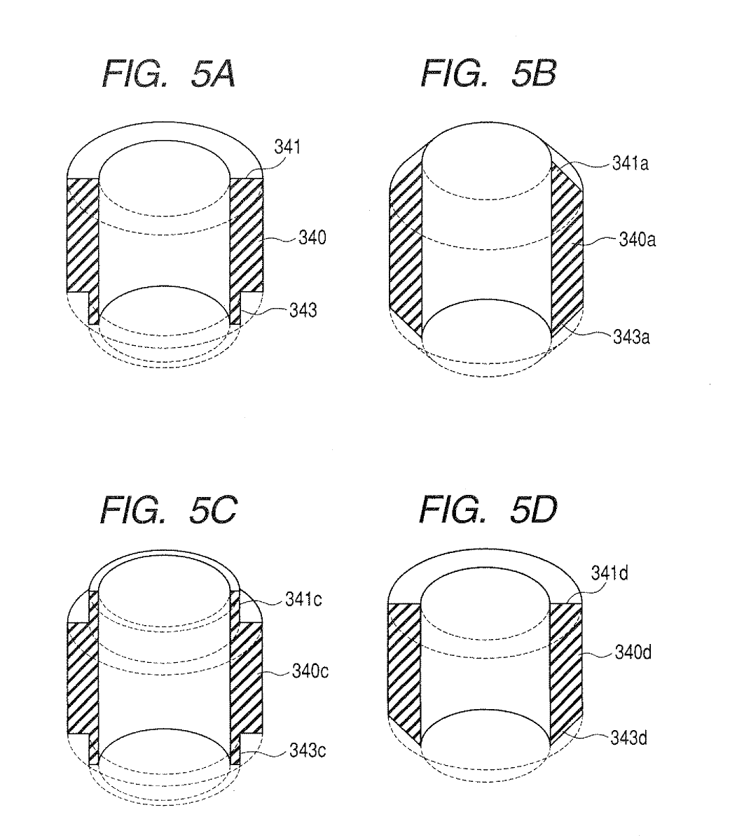

FIG. 5A represents one example of the cylindrical elastic member 340 used in the gas sensor 1 of the first embodiment shown in FIG. 1, FIGS. 2A and 2B. With the structure shown in FIG. 5A, the cylindrical elastic member 340 has the upper end 341 each taking the form of a flattened shape extending in a radial direction with the lower end 343 formed in a stepped structure with a reduced diameter.

FIG. 5B represents another example of the cylindrical elastic member 340a used in the gas sensor 1A of the second embodiment shown in FIGS. 3 and 4. With the structure shown in FIG. 5B, the cylindrical elastic member 340a has the upper and lower ends 341a and 343a formed in tapered conical profiles, respectively, which decrease in diameter toward distal ends of the cylindrical elastic member 340a.

The cylindrical elastic member 340a may be modified in structure to provide a cylindrical elastic member 340c as shown in FIG. 5C. With such a structure, the cylindrical elastic member 340c has upper and lower ends formed in thin-walled cylindrical portions 341c and 343c, respectively, with an accompanying result similar to that of the cylindrical elastic member 340a of the second embodiment shown in FIG. 5B. As shown in FIG. 5D, further, a cylindrical elastic member 340d may have an upper end 341d formed in a flattened shape extending in a radial direction with a lower end 343d formed in a nearly tapered conical shape.

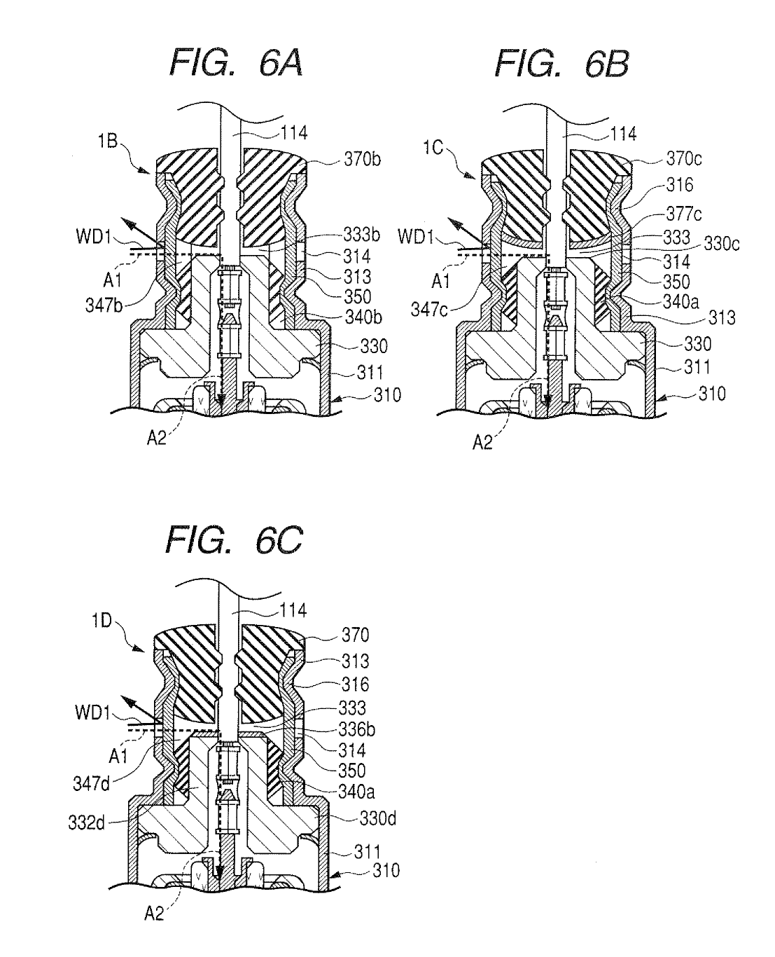

FIGS. 6A to 6C are major cross-sectional views representing various modifications on essential parts of gas sensors applicable to various embodiments according to the present invention.

With a gas sensor 1B of a first modified form shown in FIG. 6A, a columnar elastic sealing member 370b and a cylindrical elastic member 340b are integrally formed. In particular, the columnar elastic sealing member 370b has a lower end portion axially extending downward to integrally form the cylindrical elastic member 340b in a coaxial relationship. The columnar elastic sealing member 370b has an intermediate area formed with a plurality of circumferentially spaced reference gas guide passages 333a in fluid communication with the air holes 314 formed in the small diameter portion 313 of the casing 310, respectively. Each of the reference gas guide passages 333a has an opening diameter greater than that of each air hole 314.

With a gas sensor 1C of a second modified form shown in FIG. 6B, a columnar elastic sealing member 370c has a lower end face formed with recessed portions 377c that are axially indented in a direction closer to a base end of the gas sensor 1C. With such a structure, the columnar elastic sealing member 370c is compressed when caulking the small diameter portion 313 of the casing 310 at the second caulked portion 316. This causes the lower end face 377c to swell into contact with an upper end face 330c of the insulator 330 with no risk occurring for the reference gas guide passages 333 to be blocked. This allows atmospheric air to be easily admitted to the gas-concentration detecting element 10 in a highly reliable manner as indicated by the arrow A2.

With a gas sensor 1D of a third modified form shown in FIG. 6C, an insulator 330d has a small diameter portion 332d whose upper end face is formed with radially extending recessed portions 336b that are axially indent toward a leading end portion of the gas sensor 1D. If the columnar elastic sealing member 370 is compressed when caulking the small diameter portion 313 of the casing 310 at the second caulked portion 316, the lower end face of the columnar elastic sealing member 370 is caused to swell downward into contact with the upper end face of the insulator 330d. However, no risk occurs for the reference gas guide passage 333 to be blocked. This allows atmospheric air to be admitted to the gas-concentration detecting element 10 in a highly reliable manner as indicated by the arrow A2.

These modified structures may be employed in combination and may be suitably applied to other gas sensors of various embodiments described below.

### Third Embodiment

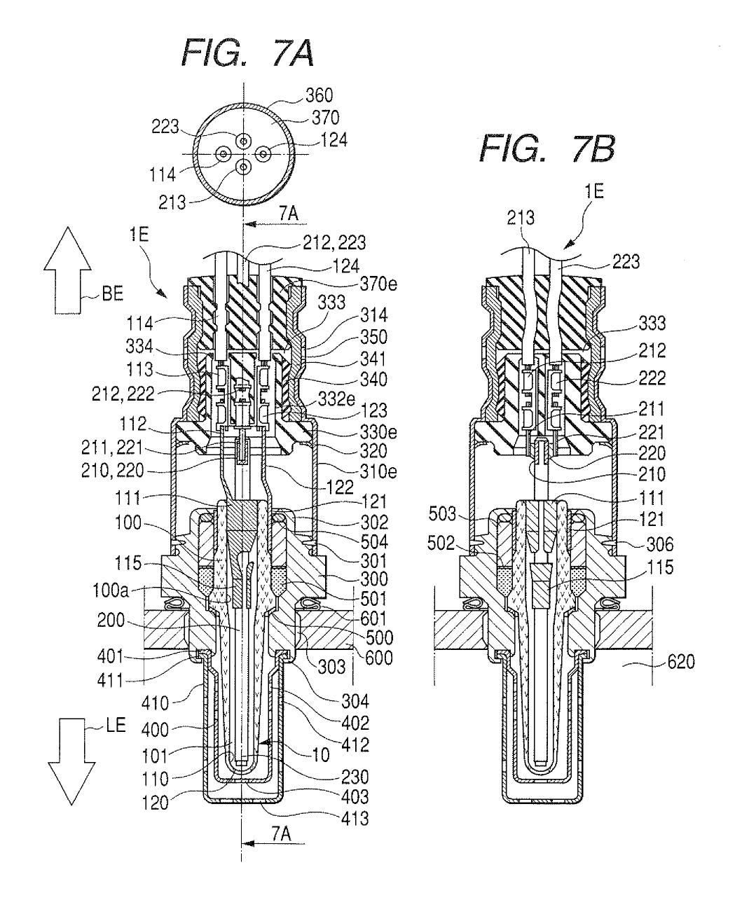

A gas sensor 1E of a third embodiment according to the present invention will be described below in detail with reference to FIGS. 7A and 7B.

The gas sensor 1E of the third embodiment has the same component parts as those of the gas sensor 1 of the second embodiment shown in FIGS. 3 and 4 with like or corresponding component parts bearing like reference numerals to omit redundant description and description will be made with a focus on featuring structures of the present embodiment.

FIG. 7A is a cross-sectional view showing an overall structure of the gas sensor 1E of the third embodiment and FIG. 7B is a cross-sectional view taken on line 7A-7A of FIG. 7A.

The gas sensor 1E of the third embodiment differs from the gas sensor 1A of the second embodiment in that the measuring electrode layer 120 is electrically insulated from the housing 300 and a heater 200 is incorporated for activating the gas-concentration detecting element 10. The second embodiment may be applied to a gas sensor required to detect a gas concentration with higher precision than that required in the first embodiment.

The metallic connector fitting 111, having a tubular portion partly cut away, is slightly larger in diameter than the inner hole 100a of the solid electrolyte substrate body 100. The metallic connector fitting 111 is fitted to the inner hole 100a of the solid electrolyte substrate body 100 in a constricted state to be resiliently brought into an electrical connection with the reference electrode layer 110. The metallic connector fitting 111 has a leading end portion formed with a heater holding section 115 to hold the heater 200 in a fixed place. The heater holding section 115 has a partly notched tubular portion, slightly smaller in diameter than an outer diameter of the heater 200, to which the heater 200 is inserted with the partly notched tubular portion being slightly expanded in diameter such that the heater 200 is resiliently retained in fixed place. In addition, the metallic connector fitting 111 has a base end portion formed with an axially extending terminal portion 112, which is electrically connected to the lead wire 114 via a crimping terminal 113.

A metallic connector fitting 121 has a tubular portion, partly cut away, which is slightly smaller in diameter than a head portion 100a of the solid electrolyte substrate body 100. When mounting the tubular portion of the metallic connector fitting 121, the tubular portion of the metallic connector fitting 121 is expanded in diameter to be resiliently fitted to the head portion 100a of the solid electrolyte substrate body 100 within the inner hole 100a of the solid electrolyte substrate body 100 in an electrical connection to the measuring electrode layer 120. The metallic connector fitting 121 has a base end portion formed with an axially extending terminal portion 122, which is electrically connected to a lead wire 124 via a crimping terminal 123.

The heater 200 has a base end portion formed with heater terminals 210 and 220 connected to terminal wires 211 and 221, respectively, by brazing technique. The terminal wires 211 and 221 are electrically connected to conductive wires 213 and 214 by means of crimping terminals 212 and 213, respectively.

The heater 200 has a leading end portion formed with a heating element 230 that develops heat upon receipt of electric power applied to the heater terminals 210 and 220.

The lead wires 114 and 124 and the conductive wires 213 and 223 are connected to the electronic control device (not shown). The lead wires 114 and 124 and the conductive wires 213 and 223 are supported with an insulator 330e and a columnar elastic sealing member 370e in an electrically insulating relation with the casing 310d.

The insulator 330e has a small diameter portion 332e to which the tubular elastic member 340 is fitted. Disposed between the tubular elastic member 340 and the casing 310e is the water repellent filter 350 that is placed in a fixed place by caulking.

The gas-concentration detecting element 10 is covered with cover bodies 400 and 410 formed in a double-cylinder structure for preventing the entry of water. The cover bodies 400 and 410 have plural sidewall openings 402 and 412 and plural bottom-wall openings 403 and 413, respectively, for admitting measuring gases to the gas-concentration detecting element 10 while discharging the same therefrom. The cover bodies 400 and 410 have flange portions 401 and 411 fixedly secured to the cover caulking portion 304 of the housing 300.

With the gas sensor 1E of the present embodiment, atmospheric air, admitted through the air holes 314, passes through the water repellent filter 350 with the entry of liquid being blocked. Thus, only atmospheric air is admitted through the reference gas passage 333 into a reference gas chamber 101 of the gas-concentration detecting element 10.

Further, the respective caulked portions of the cylindrical elastic member 340 and the columnar elastic sealing member 370e resiliently compress the water repellent filter 350. This allows the creeping of the water repellent filter 350 to be complemented, resulting in an increase in durability of the gas sensor 1E.

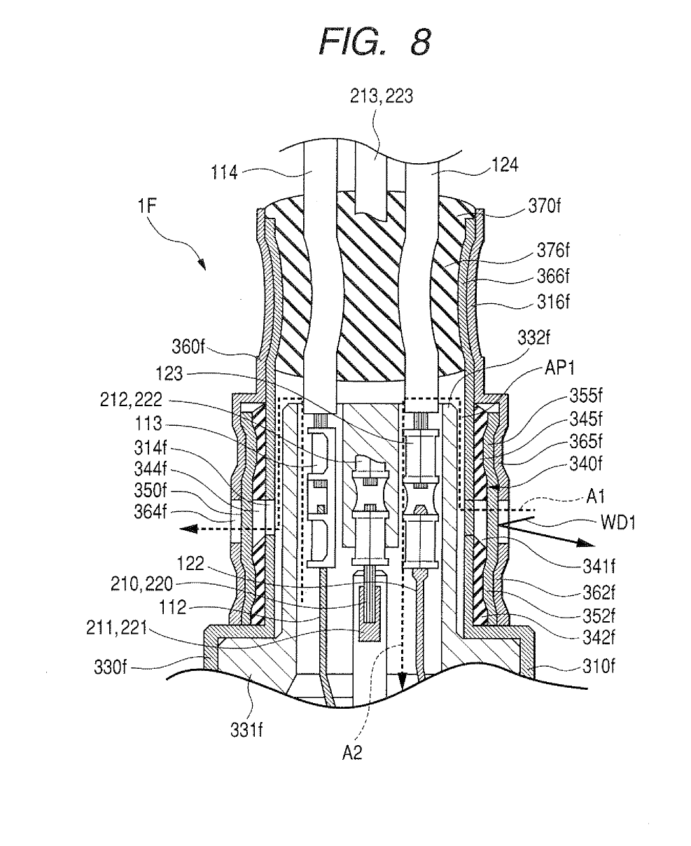

FIGS. 8 to 10 show gas sensors 1F to 1H of fourth to sixth embodiments according to the present invention, respectively. The gas sensors of these embodiments take the same basic structures as those of the gas sensor 1E of the third embodiment, shown in FIGS. 7A and 7B, except for structures of cylindrical elastic members, water repellent members and casings.

With the gas sensor 1F of the fourth embodiment according to the present invention shown in FIG. 8, first and second casings 310f and 360f are located in a coaxial relationship. Both of a cylindrical elastic member 340f and a cylindrical water repellent filter 350f are coaxially accommodated in an annular space between the first and second casings 310f and 360f. The second casing 360f is caulked such that the cylindrical elastic member 340f and the water repellent filter 350f.

With the gas sensor 1F of the fourth embodiment, further, an insulator 330f has a leading end portion formed with a large diameter portion 331f fixedly supported with the first casing 310f and a base end portion formed with a small diameter portion 332f. The cylindrical elastic member 340f and the water repellent filter 350f have respective base end portions whose end faces are distanced from air holes 314f formed in the second casing 360f to provide an annular reference gas passage API between an outer circumferential wall of the small diameter portion 332f of the insulator 330f and an inner circumferential wall of the first casing 310f. This results in increased reliability of causing a difficulty for water droplets to enter the first casing 310f.

With a view to admitting atmospheric air to the inside of the first casing 310f the cylindrical elastic member 340f and the second casing 360f have air holes 344f and 364f formed at positions in line with the air holes 314f formed in the first casing 360f.

In addition, each of the air holes 344f formed in the cylindrical elastic member 340f has an opening diameter gradually increasing in a radially outward direction. With such a structure, a water-droplet accumulating portion 341f can be formed in an area immediately below the air holes 314f. By caulking the second casing 360f at two caulked portions 365f and 362f in areas above and below ventilating portions of the water repellent filter 350f. When this takes place, the water repellent filter 350f has a base end portion and a leading end portion compressed at 355f and 352f that are densified in structure. Thus, the gas sensor 1F of the fourth embodiment has further increased waterproofing capability, thereby avoiding the entry of water drops in reliable manner.

Even with the gas sensor 1F of the fourth embodiment shown in FIG. 8, the is cylindrical elastic member 340f, forming an essential part of the present invention, provides an elastic force that complements the creeping of the water repellent filter 350f. This ensures airtightness and water-tightness for a prolonged period of time, enabling the gas sensor 1F to have increased durability.

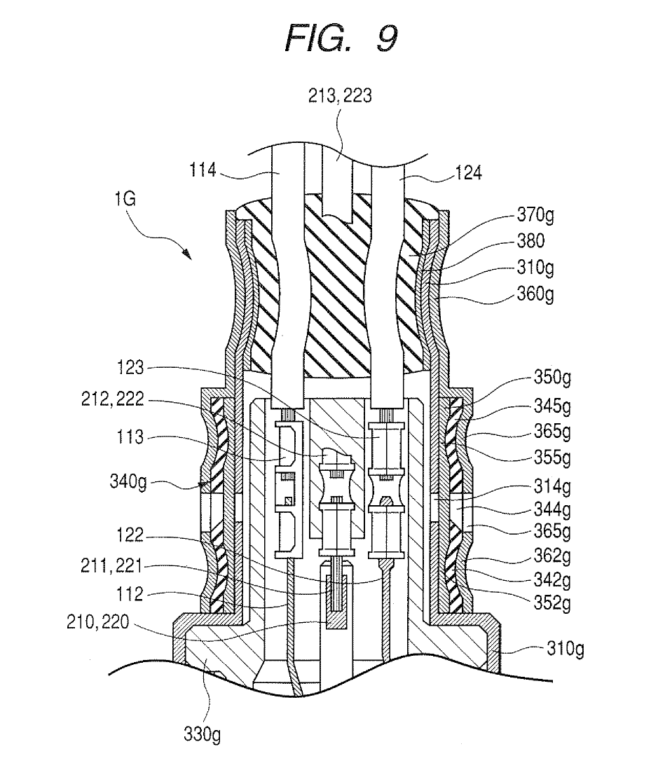

With the gas sensor 1G of the fifth embodiment according to the present invention shown in FIG. 9, a cylindrical elastic member 340g and a water repellent filter 350g are located in an order opposite to that in which the cylindrical elastic member 340f and the water repellent filter 350f are placed in the gas sensor 1F of the fourth embodiment shown in FIG. 8. That is, the gas sensor 1G of the fifth embodiment has the cylindrical elastic member 340g is disposed in a second casing 360g on an outer periphery of the water repellent filter 350g. With such a structure, the gas sensor 1FG of the fifth embodiment has the same advantageous effects as those of the gas sensor 1F of the fourth embodiment shown in FIG. 8, permitting the gas sensor 1G to have increased durability.

With the gas sensor 1H of the sixth embodiment according to the present invention shown in FIG. 10, there are provided plural cylindrical elastic members. That is, an annular space is provided between a first casing 310h and a second casing 360h to accommodate therein first and second cylindrical elastic members 340h and 390 between which a water repellent filter 350h is interposed. The first casing 310h has a small diameter portion 313h, formed with a plurality of circumferentially spaced air holes 314h, and a large diameter portion 311h that accommodates therein the insulator 330h. Likewise, the second casing 360b has a leading end portion formed with a plurality of circumferentially spaced air holes 364h. In addition, the first and second cylindrical elastic members 340h and 390 have circumferentially spaced air holes 344h and 394 in line with the air holes 314h of the first casing 310h and the air holes 364h of the second casing 360h with a view to admitting atmospheric air to an inside of the first casing 310h.

With such a structure mentioned above, the water repellent filter 350h has a leading end portion 352h and a base end portion 355h, which are compressed with first and second caulked portions 362h and 365h of the second casing 360, respectively. A ventilating area 354h is defined in fluid communication with the air holes 314h of the first casing 310h and the air holes 364h of the second casing 360h. In this case, the first cylindrical elastic member 340h is compressed to form radially compressed portions 342h and 345h at two positions by the first and second caulked portions 362h and 365h of the second casing 360h.

Thus, the leading end portion 352h and the base end portion 355h of the water repellent filter 350h are densified to provide an increased waterproofing effect, thereby preventing the incursion of water droplets in a highly reliable manner. Reference numeral 392 indicates a compressed portion of the first cylindrical elastic member 390.

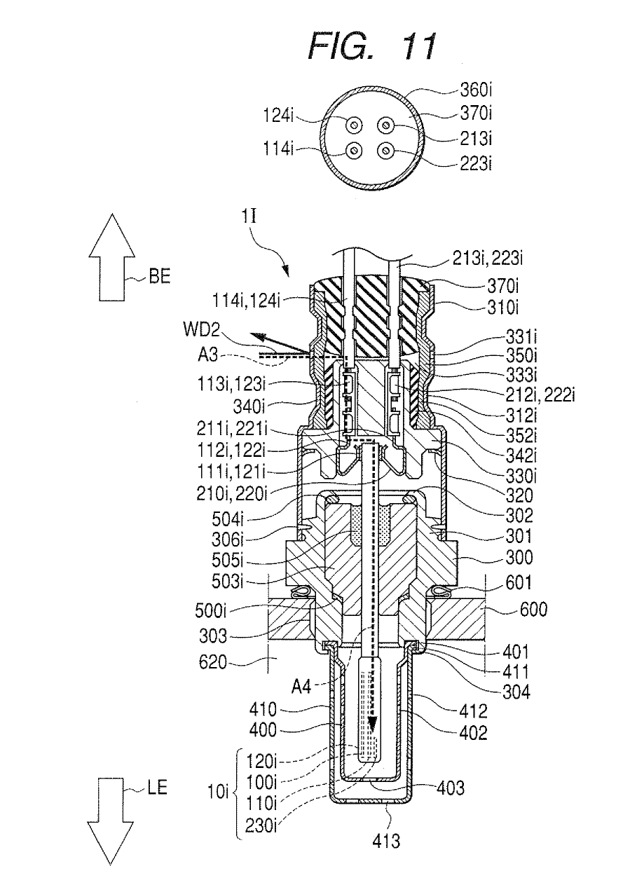

FIG. 11 shows an overall structure of a gas sensor 1I of a seventh embodiment according to the present invention. The gas sensor 1I of the present embodiment differs from the gas sensors of the first to sixth embodiments set forth above in that a stack type gas concentration detecting 10i is employed.

The stack type gas concentration detecting 10i includes a flat-plate-like solid electrolyte substrate 100i having one surface formed with a reference electrode layer 110i and the other surface formed with a measuring electrode layer 120i by printing, with the reference electrode layer 110i and the measuring electrode layer 120i being formed by printing or the like.

The stack type gas-concentration detecting element 10i further includes a reference gas chamber forming layer, stacked on the solid electrolyte substrate 100i to form a reference gas chamber through which atmospheric air is admitted to the reference electrode layer 110i as indicated by an arrow A4, and a heater layer stacked on the reference gas chamber forming layer and incorporating a heating element 230i operative to generate heat upon receipt of electric power.

The stack type gas-concentration detecting element 10i has a base end portion formed with a first area formed with a reference electrode terminal 111i, a second area formed with a measuring electrode terminal 121i and third areas formed with heater conducting terminals 210i and 220i.

The stack type gas-concentration detecting element 10i has an intermediate portion fixedly supported with an insulating member 503i fixedly retained with a housing 300 and a leading end portion formed with double-layered cylindrical cover bodies 400 and 410 to be protected in structure.

The insulating member 503h has a base end formed with a cavity filled with a filler 505i. A metallic sealing member 504i is fixedly attached to the base end of the insulating member 503i and retained with a caulked portion 302 of the housing 300. The insulator 330i has a base end portion formed with a small diameter portion to which a cylindrical elastic member 340i is fitted. The cylindrical elastic member 340i has a caulked portion 342i that is caulked with a caulked portion 312i of the casing 310i via a caulked portion 352i of a water repellent filter 350i. In addition, a reference gas guide passage 333i is defined between a columnar elastic sealing member 370i and the cylindrical elastic member 340i to admit atmospheric air, passed through air holes 331i formed in the casing 310i, into the reference gas chamber of the gas-concentration detecting element 10i in a direction as indicated by arrows A3 and A4 in FIG. 11. During flow of atmospheric air through the water repellent filter 350i as indicated by the arrow A3, water droplets are rejected by the water repellent filter 350i as indicated by an arrow WD2.

The reference electrode terminal 111i, the measuring electrode terminal 121i and heater electrode terminals 210i and 220i are electrically connected to lead wires 114i and 124i and conducting wires 213i and 223i via metallic terminals 112i, 122i, 211i and 221i and crimping terminals 113i, 123i, 212i and 222i, respectively.

By using a method similar to those used in the various embodiments set forth above, the lead wires 114i and 124i and the conducting wires 213i and 223i are fixedly supported with the casing 310i by caulking made on the water repellent filter 350i, the cylindrical elastic member 340i, the columnar elastic sealing member 370i and the insulator 330i.

With such a structure of the gas sensor 11, the water repellent filter 350i rejects the incursion of water droplets from atmospheric air passing through the air holes 331i of the casing 310i as indicated by the arrow WD2. The, atmospheric air is admitted through the solid electrolyte substrate 100i to be guided to the reference electrode layer 110i as indicated by the arrow A4.

With the gas sensor 1I of the present embodiment shown in FIG. 11, the cylindrical elastic member 340i compliments the creeping of the water repellent filter 350i. This enables the gas sensor 11 of the present embodiment to have the same advantageous effects as those of the various embodiments discussed above, enabling the realization of a gas sensor with increased ventilating capability and waterproofing effect as well as increased durability.

While the present invention has been described above with reference to the gas sensors of the various embodiments, it will be appreciated by those skilled in the art that various modifications and alternatives to those details could be developed in light of the overall teachings of the disclosure without departing from the scope of the present invention.

For instance, while the gas sensors of the various embodiments have been described above as applied to the oxygen concentration sensors including the concentration detecting element with oxygen ion conductivity whose inner and outer walls are formed with the electrode layers, respectively, the present invention may also be suitably applied to a NOx sensor or the like including a measuring section formed with a plurality of electrode layers and a solid electrolyte layer.

What is claimed is:

1. A gas sensor comprising:
a gas concentration sensing element composed of a solid electrolyte substrate body, having one surface, formed with a reference electrode layer exposed to a reference gas, and the other surface formed with a measuring electrode layer exposed to measuring gases for detecting a concentration of a specified component contained in the measuring gases;
a nearly cylindrical casing for accommodating therein the gas concentration sensing element and having a base end portion formed with air holes to admit atmospheric air as the reference gas to an inside of the casing;
a lead wire connected to at least one of the reference electrode layer and the measuring electrode layer and having one end extracted to an outside of the gas sensor;
an insulator with which the lead wire is supported in an electrically insulating relationship with respect to the casing;
a nearly columnar sealing member covering an outer circumferential periphery of the lead wire and fixedly secured to the casing at the base end portion thereof;
a water repellent filter, operative to permit the reference gas to permeate while blocking a liquid from permeating, which has a nearly cylindrical shape and is interposed between the casing and the insulator; and
an elastic member having a cylindrical shape and interposed in at least one of an area between the water repellent filter and the casing and another area between the water repellent filter and the insulator;
wherein when caulking the casing, the water repellent filter and the cylindrical elastic member are fixedly secured in a position between the casing and the insulator.

2. A gas sensor comprising:
a gas concentration sensing element composed of a solid electrolyte substrate body, having one surface, formed with a reference electrode layer exposed to a reference gas, and the other surface formed with a measuring electrode layer exposed to measuring gases for detecting a concentration of a specified component contained in the measuring gases;
a first nearly cylindrical casing for accommodating therein the gas concentration sensing element;
a second nearly cylindrical casing coaxially mounted on the first nearly cylindrical casing at an outside thereof;
the first and second casings having base end portions formed with air holes, respectively, to admit atmospheric air as the reference gas to an inside of the first nearly cylindrical casing;
a lead wire connected to at least one of the reference electrode layer and the measuring electrode layer and having one end portion extracted to an outside of the gas sensor;
a nearly columnar sealing member covering an outer circumferential periphery of the lead wire and fixedly secured to the first casing at the base end portion thereof;
an insulator holding the lead wire in an electrically insulating relationship with respect to the first casing;
a water repellent filter permitting the reference gas to permeate while blocking a liquid from permeating; and
an elastic member formed in a cylindrical shape and interposed in at least one of an area between the water repellent filter and the first casing and another area between the water repellent filter and the second casing;
wherein the water repellent filter, formed in a cylindrical shape, is interposed between the first and second casings; and
wherein by caulking the second casing, the water repellent filter and the cylindrical elastic member are fixedly secured in a position between the first and second casings.

3. The gas sensor according to claim 1, wherein:
the cylindrical elastic member has a rubber hardness ranging from 50 to 90 (in Durometer A) obtained under JIS-K6253: 2006 or ISO48: 1994 and ISO7916-1:2004.

4. The gas sensor according to claim 1, wherein:
the cylindrical elastic member has a wall thickness of 1 mm or more.

5. The gas sensor according to claim 1, wherein:
the cylindrical elastic member has upper and lower ends at least one of which has a deformation absorbent region that absorbs a deformation of the cylindrical elastic member resulting from thermal stress or mechanical stress applied to at least one of the upper and lower ends.

6. The gas sensor according to claim 5, wherein:
the deformation absorbent region includes a thin wall portion having at least one of a tapered shape, formed on the cylindrical elastic member at a leading end extending in a decreasing diameter toward a leading end of the gas sensor, a round shape and a stepped shape.

7. The gas sensor according to claim 1, wherein:
the insulator has a lead wire insertion bore, permitting the lead wire to be inserted, which has at least one part formed with a longitudinally extending recessed portion spaced from an outer diametrical wall of the lead wire by a clearance of 0.1 mm or more.

8. The gas sensor according to claim 1, wherein:
the lead wire has a sheath end portion held in fitting engagement with the lead wire insertion bore.

9. The gas sensor according to claim 1, further comprising:
a reference gas guide passage defined between a lower end face of the columnar sealing member and an upper end face of the cylindrical elastic member.

10. The gas sensor according to claim 9, wherein:
the columnar sealing member and the cylindrical elastic member are disposed in the casing to be separate from each other by a given distance to form the reference gas guide passage between the lower end face of the columnar sealing member and the upper end face of the cylindrical elastic member.

11. The gas sensor according to claim 9, wherein:
the reference gas guide passage includes a recessed portion formed on the sealing member at a lower end thereof so as to be concaved toward a base end of the gas sensor.

12. The gas sensor according to claim 9, wherein:
the reference gas guide passage includes a recessed portion formed on the insulator at an upper end thereof so as to be concaved toward a leading end portion of the gas sensor.

13. The gas sensor according to claim 9, wherein:
the columnar sealing member has a lower end portion formed with a cylindrical extension integrally formed with the cylindrical elastic member; and
wherein the reference gas guide passage includes a passage formed in the cylindrical extension in fluid communication with the air holes of the cylindrical casing.

14. The gas sensor according to claim 9, wherein:
the reference gas guide passage has an opening portion with an opening diameter greater than that of an inside area of the reference gas guide passage.

15. The gas sensor according to claim 1, wherein:
the water repellent filter is made of foaming material.

16. The gas sensor according to claim 1, wherein:
the water repellent filter includes a cylindrical body made of polytetrafluoroethylene.

17. A gas sensor comprising:
a gas concentration sensing element composed of a solid electrolyte substrate body, having one surface, formed with a reference electrode layer exposed to a reference gas, and the other surface formed with a measuring electrode layer exposed to measuring gases for detecting a concentration of a specified component contained in the measuring gases;
a nearly cylindrical casing having a large diameter portion and a small diameter portion for accommodating therein the gas concentration sensing element and having air holes formed in the small diameter portion to admit atmospheric air as the reference gas to an inside of the casing;
a lead wire axially extending through the small diameter portion of the casing and connected to at least one of the reference electrode layer and the measuring electrode layer and having one end extracted to an outside of the gas sensor;
an insulator having a large diameter portion, fixedly supported in the large diameter portion of the casing, and a small diameter portion extending through the small diameter portion of the casing, the small diameter portion of the insulator having a lead wire insertion bore, supporting the lead wire in an electrically insulating relationship with respect to the casing, and at least one recessed portion to allow the reference gas to pass to the gas concentration sensing element;
a nearly columnar sealing member covering an outer circumferential periphery of the lead wire and fixedly secured to the casing at a base end portion thereof;
a nearly cylindrical water repellent filter axially extending in an area between the casing and the insulator for permitting the reference gas to permeate while blocking a liquid, contained in the reference gas, from permeating; and
a cylindrical elastic member interposed in at least one of an area between the water repellent filter and the casing and another area between the water repellent filter and the insulator; and
wherein when caulking the casing, the water repellent filter and the cylindrical elastic member are fixedly secured in a position between the casing and the insulator.
